(19) United States
(12) Patent Application Publication
(10) Pub. No.: US 2026/0266264 A1
(43) Pub. Date: Sep. 10, 2026

(54) ESTIMATING VELOCITY IN A FORE-AFT DIRECTION OF A TOP OF A WIND TURBINE TOWER BASED ON BLADE FLAP LOADS

(71) Applicant: VESTAS WIND SYSTEMS A/S, Aarhus N (DK)

(72) Inventors: Mikael Aslak SVENSTRUP, Hinnerup (DK); Anders Druedahl THURLOW, Silkeborg (DK); Jesper Sandberg THOMSEN, Hadsten (DK); Antonio Rosas GARCEZ LENCASTRE, Porto (PT)

(21) Appl. No.: 19/162,812

(22) PCT Filed: Mar. 5, 2024
(86) PCT No.: PCT/DK2024/050042

§ 371 Date: Sep. 5, 2025

(30) Foreign Application Priority Data
Mar. 6, 2023 (DK) PA202370120

(51) Int. Cl. F03D 17/00; F03D 7/02

(52) U.S. Cl. CPC F03D 17/006; F03D 7/0224; F03D 7/0302; F03D 17/028; F03D 17/034; F05B 2270/807

(57) ABSTRACT

The invention estimates a velocity of a top of a tower of a wind turbine that has a rotor and a plurality of rotor blades. The invention involves obtaining a measured acceleration indicative of tower top acceleration in the fore-aft direction. The invention involves obtaining an estimated thrust force experienced by the rotor, and providing this estimate as input to a defined observer model describing motion of the tower top. The invention involves determining an error based on a difference between the measured acceleration and an estimated acceleration obtained using the observer model, and providing the error as input to the observer model as part of a feedback loop. The invention involves estimating, using the observer model, velocity of the tower top in the fore-aft direction. The estimated thrust force is obtained based on measured flap loading on the rotor blades.

### TECHNICAL FIELD

The invention relates to estimating velocity, and optionally position/deflection, of a top of a wind turbine tower or nacelle and, in particular, estimating tower top velocity based on flap loads experienced by rotor blades of the wind turbine.

### BACKGROUND

Wind turbines as known in the art have a tower supporting a nacelle and a rotor with a plurality of pitch-adjustable rotor blades. A wind turbine is prone to vibrations or oscillations, such as tower, nacelle, or rotor blade movement. It is known that certain types of oscillations may be damped by active pitching of the rotor blades or adjusting generator torque. Control strategies for adjusting blade pitch or generator torque can be used to maximise energy production of a wind turbine while minimising loads experienced by various components of the wind turbine.

Such control strategies determine control outputs based on various inputs relating to operation of the wind turbine and/or conditions in the vicinity of the wind turbine. An example of such an input may relate to movement of the wind turbine tower, e.g. tower position, velocity or acceleration. Indeed, the movement of the wind turbine tower in one or both of a fore-aft direction and a side-side direction of the wind turbine may be needed for different control strategies.

Some wind turbine control strategies aim to counter the effects of transient load events, e.g. wind gusts, which can cause extreme loading of one or more wind turbine components. In order to detect and react quickly enough to counter extreme loading caused by transient events, control strategies need to be provided with accurate estimates or determinations of relevant input parameters. In one example, previous approaches for obtaining a velocity and/or position of a wind turbine tower may use a leaky integrator applied to a measured tower acceleration signal. A drawback of such an approach is that it can introduce a delay to the obtained tower velocity and/or position signal. Estimations based on measured tower acceleration signal may suffer from accuracy issues as a result of signal noise and drift because of integration of the signal.

It is against this background to which the present invention is set.

### SUMMARY OF THE INVENTION

According to an aspect of the invention there is provided a method of estimating a velocity of a top of a tower of a wind turbine. The wind turbine comprises a rotor and a plurality of rotor blades. The method comprises obtaining a measured acceleration signal indicative of measured acceleration of the top of the tower in the fore-aft direction of the wind turbine. The method comprises obtaining an estimated thrust force signal indicative of estimated thrust force experienced by the rotor. The method comprises providing the estimated thrust force signal as input to a defined observer model describing motion of the top of the tower. The method comprises determining an error signal based on a difference between the measured acceleration signal and an estimated acceleration signal obtained using the defined observer model. The method comprises providing the error signal as input to the observer model as part of a feedback loop. The method comprises determining, using the defined observer model, a velocity signal indicative of estimated velocity of the top of the tower in the fore-aft direction of the wind turbine. The estimated thrust force signal is obtained based on an obtained blade flap load signal indicative of measured flap loading on the rotor blades.

The method may comprise for each of the plurality of rotor blades, receiving a sensor signal, from a blade load sensor of the respective rotor blade, indicative of measured flap loading on the respective rotor blade. The method may comprise adding the received sensor signals to obtain the blade flap load signal. The method may comprise applying a scaling factor to the (added) sensor signals to map blade flap moments of the sensor signals to thrust force of the blade flap load signal.

The estimated thrust force signal may be obtained based on a determined quasi-static thrust force signal indicative of quasi-static thrust force experienced by the rotor. The quasi-static thrust force may be for (based on) current operating conditions of the rotor.

The quasi-static thrust force signal may be determined using a defined blade element model.

The method may comprise applying a high-pass filter to the obtained blade flap load signal. The method may comprise adding the high-pass filtered blade flap load signal to the quasi-static thrust force signal to obtain the estimated thrust force signal. A low-pass filter may be applied to the quasi-static thrust force signal prior to the addition to the high-pass filtered blade flap load signal.

The method may comprise obtaining a collective pitch signal as output from a fore-aft tower damping control routine of the wind turbine, the collective pitch signal being for reducing oscillation amplitude of the top of the tower in the fore-aft direction of the wind turbine. The method may comprise determining a gain based on the determined velocity signal. The method may comprise applying the gain to the collective pitch signal to obtain a gain-adjusted collective pitch signal. The method may comprise controlling the rotor blades in accordance with the gain-adjusted collective pitch signal.

If the determined velocity signal indicates that the estimated velocity is less than a lower velocity threshold then the gain may be determined to be a minimum gain value.

If the determined velocity indicates that the estimated velocity is greater than or equal to an upper velocity threshold then the gain may be determined to be a maximum gain value.

The gain may be determined to increase from the lower velocity threshold to the upper velocity threshold. Optionally, the increase may be a linear increase.

The gain may be determined based on the estimated thrust force signal.

If the estimated thrust force indicated by the estimated thrust force signal is less than a lower thrust threshold or the estimated velocity indicated by the determined velocity signal is less than a lower velocity threshold, then the gain may be determined to be a minimum gain value.

The gain may be determined to be a maximum gain value only if the estimated thrust force is greater than or equal to an upper thrust threshold, greater than the lower thrust threshold, and the estimated velocity is greater than or equal to an upper velocity threshold, greater than the lower velocity threshold.

The collective pitch signal may be determined based on the determined velocity signal.

The method may comprise determining, using the defined observer model, a position signal indicative of estimated position of the top of the tower in the fore-aft direction of the wind turbine. The collective pitch signal may be determined based on the determined position signal.

According to another aspect of the invention there is provided a non-transitory, computer-readable storage medium storing instructions thereon that, when executed by one or more processors, cause the one or more processors to perform the method defined above.

According to another aspect of the invention there is provided a controller for estimating a velocity of a top of a tower of a wind turbine. The wind turbine comprises a rotor and a plurality of rotor blades. The controller is configured to obtain a measured acceleration signal indicative of measured acceleration of the top of the tower in the fore-aft direction of the wind turbine. The controller is configured to obtain an estimated thrust force signal indicative of estimated thrust force experienced by the rotor. The controller is configured to provide the estimated thrust force signal as input to a defined observer model describing motion of the top of the tower. The controller is configured to determine an error signal based on a difference between the measured acceleration signal and an estimated acceleration signal obtained using the defined observer model. The controller is configured to provide the error signal as input to the observer model as part of a feedback loop. The controller is configured to determine, using the defined observer model, a velocity signal indicative of estimated velocity of the top of the tower in the fore-aft direction of the wind turbine. The estimated thrust force signal is obtained based on an obtained blade flap load signal indicative of measured flap loading on the rotor blades.

According to another aspect of the invention there is provided a wind turbine comprising a controller as defined above.

### BRIEF DESCRIPTION OF THE DRAWINGS

Examples of the invention will now be described with reference to the accompanying drawings, in which:

FIG. 1 is a schematic diagram of a wind turbine in accordance with an example of the invention:

FIG. 2 schematically illustrates a controller for estimating the tower top velocity of the wind turbine in FIG. 1 in accordance with an example of the invention;

FIG. 3 shows the steps of a method performed by the controller of FIG. 2 in accordance with an example of the invention;

FIG. 4 schematically illustrates a controller of the wind turbine of FIG. 1 for reducing an amplitude of oscillations of the wind turbine tower; and,

FIG. 5 shows a schematic plot indicating a gain to be applied to a collective pitch offset signal determined by the controller of FIG. 4, the gain being a function of a thrust force and a tower top velocity of the wind turbine of FIG. 1.

### DETAILED DESCRIPTION

The present invention beneficially provides an approach for obtaining a more accurate estimate of movement of a wind turbine tower, e.g. in a fore-aft direction of the wind turbine. The invention in particular provides an improved method for estimating a velocity of a top of a wind turbine. More accurate estimates of tower top acceleration and position may also be obtained. Unlike some previous approaches in which tower top velocity estimates have an inherent delay, the tower top velocity estimate of the present invention benefits from reacting quickly to changes experienced by the wind turbine. This is achieved by taking into account measurements of loading experienced by the wind turbine blades in the tower top velocity estimation. A transient event such as a wind gust is detected or experienced earlier in the loading experienced by the wind turbine blades, and hence using measurements of such loading in an estimate of tower top velocity results in a more accurate estimation that does not have the delays in the signal apparent in other, previous approaches.

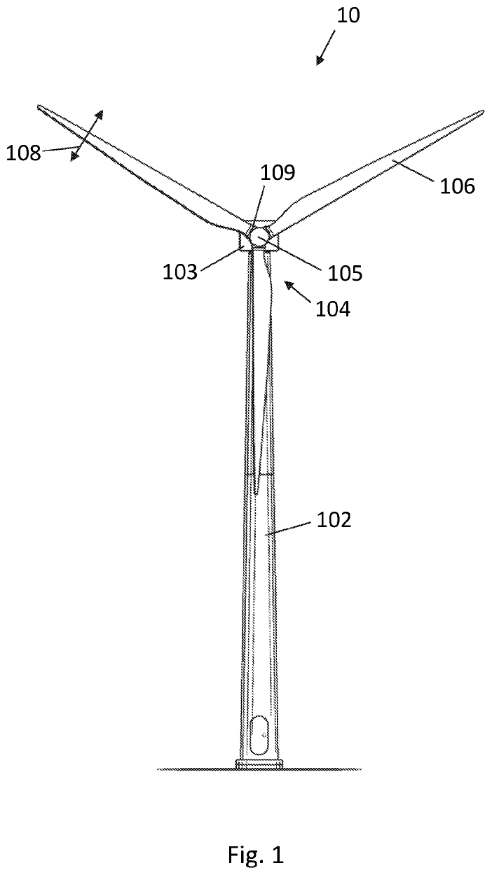

FIG. 1 illustrates, in a schematic view, an example of a wind turbine 10. The wind turbine 10 includes a tower 102, a nacelle 103 disposed at the apex of, or atop, the tower 102, and a rotor 104 operatively coupled to a generator housed inside the nacelle 103. In addition to the generator, the nacelle 103 houses other components required for converting wind energy into electrical energy and various components needed to operate, control, and optimise the performance of the wind turbine 10. The rotor 104 of the wind turbine 10 includes a central hub 105 and three rotor blades 106 that project outwardly from the central hub 105. Moreover, the wind turbine 10 comprises a control system or controller (not shown in FIG. 1). The controller may be placed inside the nacelle 103, in the tower 102 or distributed at a number of locations inside (or externally to) the turbine 10 and communicatively connected to one another. The rotor blades 106 may be pitch-adjustable. The rotor blades 106 may be adjusted in accordance with a collective pitch setting, where each of the blades are set to the same pitch value. The rotor blades 106 may additionally be adjustable in accordance with individual pitch settings, where each blade 106 may be provided with an individual pitch setpoint.

The wind turbine 10 includes blade load sensors placed at, or in the vicinity of, each blade root 109 in a manner such that the sensor detects loading in the blade 106. Blade load signals from such sensors may for instance be used to determine how to adjust the pitch of each of the individual blades 106. Depending on the placement and the type of sensor, loading may be detected in the flap (flapwise) direction (in/out of plane) or in the edge (edgewise) direction 108 (in-plane). Such sensors may be strain gauge sensors or optical Bragg-sensors, for instance. As the sensors are placed on the rotating blades 106, such load signals for each of the adjustable rotor blades 106 are measured in the rotating reference frame of the rotor 104.

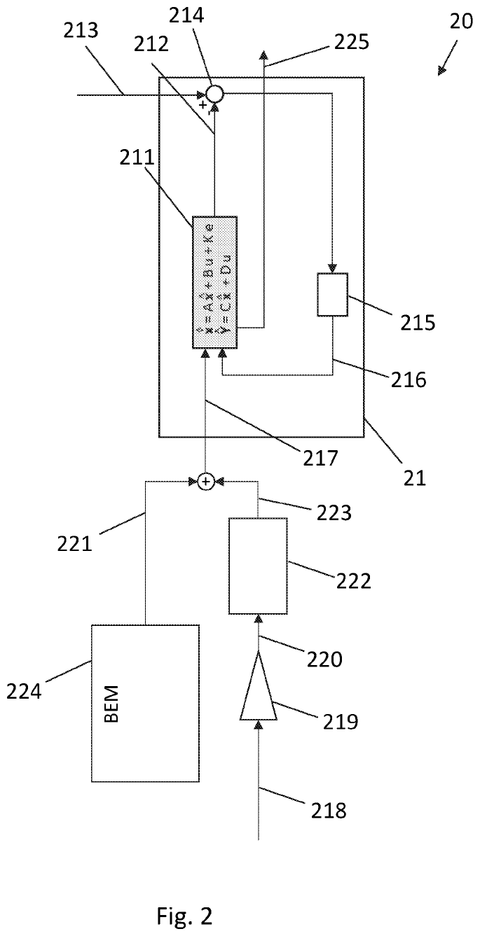

FIG. 2 schematically illustrates how a velocity of the top of the tower 102 in a fore-aft direction of the wind turbine 10 may be estimated according to a controller or estimation scheme 20 in accordance with an example of the invention. The fore-aft direction is the direction perpendicular to a plane of the rotor 104 (e.g. in a direction in-out of the page in FIG. 1). The estimation scheme 20 uses an observer model approach. The scheme 20 includes an observer block 21 with a defined observer model 211, which may be any suitable model known in the art for describing motion of the top of the tower 102 or the nacelle 103. For instance, the model may be a one-dimensional (linear) spring damper model as is known in the art; however, more complex models may also be used. As is known, the model defines a state vector x consisting of the states of the system being modelled, i.e. a set of variables used to describe the system dynamics, which are embodied in a state space matrix A, and another (input) vector u representing external inputs to the system, e.g. wind speed variation, which affect the state dynamics through an input matrix B. Also as is known, the model defines an output vector V that is obtained based on an output matrix C acting on the state vector 2 added to a feedforward matrix D acting on the input vector u. The model 211 further includes an error term e multiplied by a gain K.

The observer model 211 provides as output an estimation of tower top acceleration 212 in the fore-aft direction. The error e between the estimated acceleration 212 and a measured acceleration signal 213 is determined at processing block 214. The measured acceleration signal is indicative of a measured acceleration of the tower top or nacelle 103 in the fore-aft direction, and may be obtained from an accelerometer positioned in the nacelle 103 or at the top of the tower 102. The error e is multiplied by a gain K at the processing block 215, and the gain-adjusted error signal 216 is fed back into the observer model 211 as part of a feedback loop.

The observer model 211 also takes as input an estimated thrust force signal 217. In the example illustrated in FIG. 2, the thrust force is estimated based on measured blade flap loads from blade load sensors on the rotor blades. The measured flap load may be obtained by combining, e.g. averaging, adding, the measured flap load signal obtained from the sensor of each rotor blade 106. Alternatively, the measured flap load may be based on a flap load signal from only one of the blade load sensors. The blade flap load measurement is indicative of the bending moment at the root 109 of the rotor blade 106.

As shown in FIG. 2, the sum of blade flap bending moments 218 obtained from the blade load sensor on each rotor blade 106 is used to obtain rotor thrust force 220 at processing block 219. The moment-to-force processing at block 219 may be in the form of a gain obtained from a blade element momentum model (BEM). As the gain is obtained from the BEM, it is a quasi-static signal, and it maps the blade flap loads to rotor thrust for (approximately) the current operating point of the wind turbine.

As is known in the art, a BEM breaks down a rotor blade into several small elements (along its span) and then determines the forces and moments acting on each of these elements. These forces are then integrated across the entire blade to obtain the forces and moments experienced by the rotor blade. In the present context, a BEM provides a signal that can map a sum of measured flap loads (moment/torque) of unit Nm into a rotor thrust force of unit N, i.e. the mapping signal of unit 1/m. Specifically, the BEM may calculate forces and moments on the rotor blade 106 based on lift and drag curves for individual blade elements of the blades, which are then summed to the (full) rotor 104. The BEM may in particular calculate the forces and moments also based on relative blade element location (twist, prebend, radius, etc.), blade pitch angle, rotor speed (to determine the speed of each individual pitch element), air density, and generator power (used to estimate effective rotor wind speed).

The forces and moments are represented at a centre of the rotor hub/an intersection point of the rotor blades 106; however, as mentioned above, the blade load sensors are positioned at or near to (e.g. up to a few metres from) a root of the rotor blades 106, which is some radius or distance out from the centre of the rotor hub. This may be used to obtain rotor thrust force from the blade flap loads measured by the blade load sensors of the rotor blades 106. In particular, the blade moment from the BEM is translated to a moment at the actual location of the blade load sensor on the rotor blade 106. A relationship between thrust and flap load measurements can then be determined/obtained.

In some examples, the thrust force 220 obtained from the measured flap loads could be used as the estimated thrust force signal 217 (for input into the observer model 211). However, in the described example, the estimate of thrust force 217 is obtained from two separate sources. In addition to the blade flap load measurements, a quasi-static estimate of thrust force 221 is obtained. In order that the two estimates can be combined to obtain the estimated thrust force 217 for input into the observer model 211, the output thrust force 220 from the processing block 219 is high-pass filtered at processing block 222, and this high-pass filtered estimate 223 is combined, e.g. added, to the quasi-static estimate 221 to obtain the estimated thrust force signal 217. The quasi-static estimate 221 may be obtained using a BEM 224, as described above. In particular, as mentioned above, the BEM 224 estimates rotor thrust (used here as the quasi-static signal 221) and estimated blade bending moment (used above for block 219).

As an alternative, the quasi-static thrust force signal 221 may be estimated based on a defined equation that depends on a thrust coefficient. In one example, the thrust force Fₜ may be estimated according to:

$${F}_{t} = \frac{1}{2} ρ {R}^{2} {C}_{t} ( θ , \frac{ω R}{V} ) {V}^{2}$$

where ρ is air density, R is a radius of the rotor 104, V is wind speed, θ is pitch angle of the rotor blades 106, ω is rotational speed of the rotor 104, and the thrust coefficient Cₜ is a defined function of pitch angle θ and tip speed ratio ωR/V.

Basing the estimation of thrust force on blade flap load measurements means that transient events, e.g. rapid changes in wind speed, can be detected quickly. By using only the high frequency content of the thrust force estimate obtained based on the blade flap load measurements, and combining this with a quasi-static estimate of thrust force, a more accurate overall thrust estimate may be obtained. This is because the quasi-static estimate may be more accurate for low frequency content, but can be relatively slow to react, meaning that dynamic changes of the thrust may not be captured.

Referring to FIG. 2, the velocity signal 225 indicative of estimated velocity (or speed) of the tower top in the fore-aft direction can then be obtained from the observer model 211. The use of the observer model to obtain the velocity signal may beneficially provide a more accurate estimate of velocity than other approaches. A position signal 225 indicative of estimated position of the tower top in the fore-aft direction can also be obtained from the observer model 211.

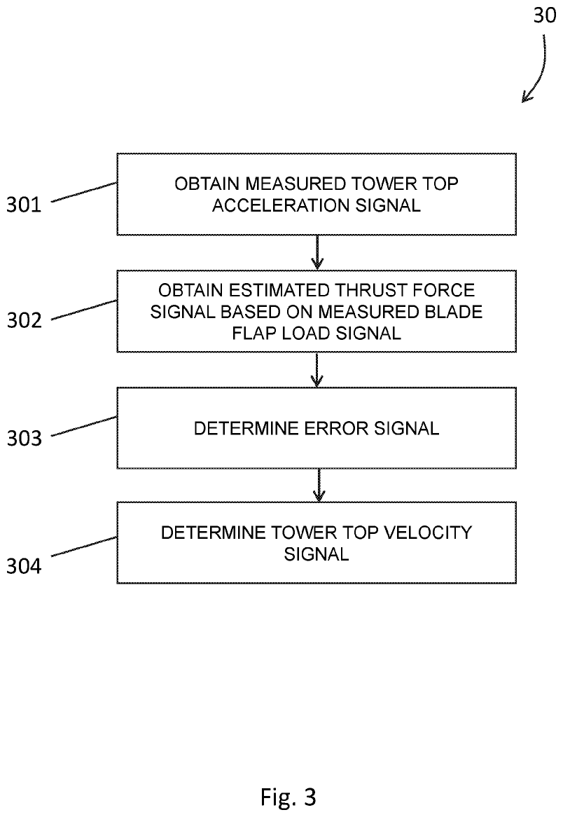

FIG. 3 summarises the steps of a method 30 performed by the controller or estimation scheme 20 in accordance with the described invention. At step 301, the method 30 involves obtaining a measured acceleration signal 213 indicative of measured acceleration of the top of the tower 102 in the fore-aft direction of the wind turbine 10, e.g. using an accelerometer positioned in the nacelle 103 or at the tower top.

At step 302, the method 30 involves obtaining an estimated thrust force signal 217 indicative of estimated thrust force experienced by the rotor 104. This estimated thrust force signal 217 is in particular obtained based on an obtained blade flap load signal 218 indicative of measured flap loading on the rotor blades. A thrust force estimate 220 may be obtained from the measured flap loads using a gain obtained from a BEM, for instance. In some examples, the estimated thrust force signal 217 may be obtained additionally based on an estimated quasi-static thrust force signal 221, e.g. obtained from a BEM 224. In such examples, the quasi-static thrust force signal 221 may be combined, e.g. added, with the high-frequency content of the thrust force estimate obtained using the measured flap loads 218. For instance, a high-pass filter 222 may first be applied to the thrust estimate 220 to provide a filtered thrust force estimate 223 to be combined with the quasi-static thrust estimate 221. Indeed, a low-pass filter may be applied to the quasi-static thrust force estimate 221 prior to the addition to the high-pass filtered thrust force estimate 223. In the method 30, the estimated thrust force signal 217 is provided as input to a defined observer model 211 describing motion of the top of the tower 102. The defined observer model may for instance be a one-dimensional spring damper model, or any other suitable type of model.

At step 303, the method 30 involves determining an error signal 216 based on a difference between the measured acceleration signal 213 and an estimated acceleration signal 212 obtained using the defined observer model 211. The error signal 216 is provided as input to the observer model 211 as part of a feedback loop. At step 304, the method 30 then involves determining, using the defined observer model 211, a velocity signal 225 indicative of estimated velocity of the top of the tower 102 in the fore-aft direction of the wind turbine 10.

The use of a tower top velocity signal obtained using an observer approach that estimates rotor thrust based on blade flap load measurements can be used to enable quick responses from control features/routines of the wind turbine for reducing, or preventing, loading of certain wind turbine components that may occur during transient event load cases. For instance, this may be particularly useful in Extreme Coherent Gust with Direction change (ECD) load cases. It may be that this estimated tower top velocity signal can be used to reduce loads arising from deflection of the tower top both during the initial part of the event, but also more dominantly during the second swing back of the tower (rebound load peak), where it has the potential to significantly reduce or even remove this load peak.

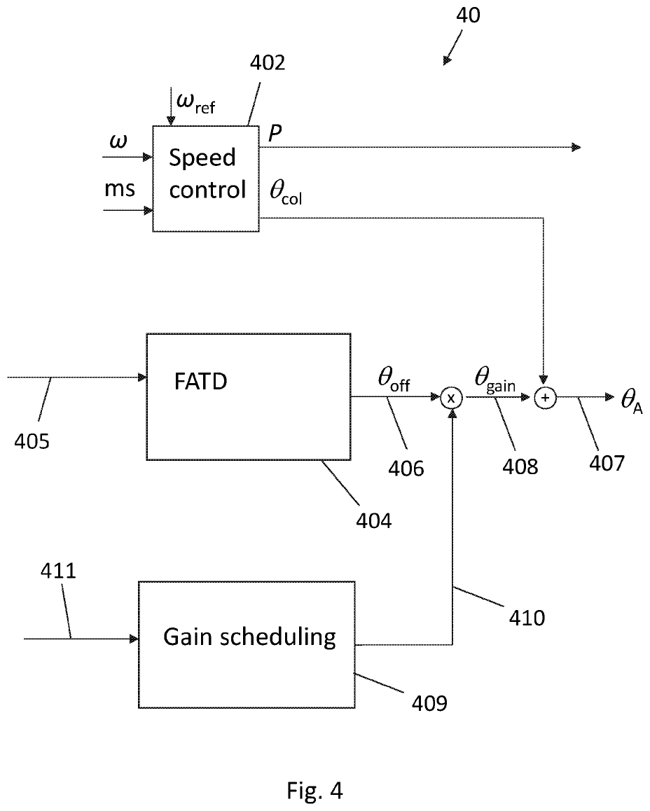

One example in which the tower top velocity signal 225 can be used by a control routine of the wind turbine to reduce the amplitude of fore-aft tower top oscillations is now described. FIG. 4 schematically illustrates elements of an example of a controller 40 of the wind turbine 10 implemented to determine pitch actuation signals capable of maximising power generation and reducing or mitigating loads experienced by one or more components of the wind turbine 10, e.g. tower 102, rotor blades 106, etc. The controller or estimation scheme 20 may be part of the controller 40, or vice versa, or they may combine as part of a system of controllers.

In the illustrated implementation, a collective pitch control module in the form of a speed controller (control module/block) 402 of the controller 40 minimises a speed error (ω−ω_{ref}) between the actual rotor speed, co, and a reference rotor speed, ω_{ref}, in order to output a requested power P (in the form of a power setpoint) and a collective pitch reference, ω_{col}. The collective pitch reference as determined by the speed controller 402, in view of the rotor speed, may also take further sensor values into account. This is referred to in FIG. 4 as a measurement set, ms, being input into the speed controller 402. The feedback speed controller 402 may be implemented by a PI (proportional-integral), PID (proportional-integral-derivative), or similar control scheme. In one example, the collective pitch control module 402 may alternatively be a model predictive controller which, based on minimising a cost function, is arranged to determine the collective pitch reference and/or the power reference.

FIG. 4 further illustrates a control block/module or pitch offset controller 404, of the controller 40. In the controller 404, pitch modification signals, or pitch reference offset values, are determined based on one or more input signals 405. In the described example, the controller 404 is, or comprises, a fore-aft tower damping (FATD) controller or control feature. The FATD controller 404 is for reducing/counteracting oscillations/vibrations of the top of the tower 102, and/or the nacelle 103, in the fore-aft direction of the wind turbine 10. In particular, the FATD controller 404 determines and outputs a collective pitch offset signal or reference, θ_{off}, 406. The collective pitch offset signal 406 is to be combined, e.g. added, to the collective pitch reference θ_{col} output from the speed controller 402 to obtain a collective pitch control signal, θ_{A}, 407 which is to be used to control the rotor blades 106. In particular, the controller 40 sends the collective pitch control signal 407 to a pitch system of the wind turbine 10 to control the pitch bearings such that the pitch of the rotor blades 106 is adjusted in accordance with the collective pitch control signal 407.

However, prior to the collective pitch offset signal 406 being added to the collective pitch reference θ_{col}, a gain may be determined and applied, e.g. via multiplication, to the collective pitch offset signal 406 obtained from the FATD controller 404 to obtain a gain-adjusted collective pitch offset signal, θ_{gain}, 408. It is this gain-adjusted collective pitch offset signal 408 that is added to the collective pitch reference θ_{col} from the speed controller 202 to obtain the collective pitch control signal 407.

A gain scheduling control block or controller 409 determines and outputs the gain 410 for applying to the collective pitch offset signal 406. The gain 410 may typically be in the form of a factor or multiple to be applied to the output from the FATD controller 404. The gain 410 is determined based on one or more input signals 411.

Referring back to the FATD controller 404, this controller 404 may determine the collective pitch offset signal 406 based on one or both of: a signal indicative of a velocity of the nacelle 103 or top of the tower 102 in the fore-aft direction; and, a signal indicative of a position of the nacelle 103 or top of the tower 102 in the fore-aft direction. That is, the input signal 405 to the FATD 404 may include the tower top fore-aft velocity and/or position.

In examples in which the nacelle or tower top position in the fore-aft direction is used by the FATD controller 404, the position signal may be obtained in any suitable manner. For instance, the position may be determined based on a measured acceleration signal indicative of the nacelle or tower top movement, where the acceleration signal may be obtained from an accelerometer positioned at the top of the tower 102 or in/on the nacelle 103. The acceleration signal may then be integrated twice as appropriate in order to obtain position. In general, any suitable filter that integrates the relevant signal may be applied to obtain velocity and position from acceleration, e.g. leaky filters. The position signal may be obtained in different ways, such as a GPS signal, an inclinometer, an inertial measuring unit (IMU), or a Kalman filter.

Basing the collective pitch offset signal 406 determined by the FATD 404 on the fore-aft position of the nacelle 103 or tower top may beneficially result in stabilisation of the nacelle 103, and may guard against problems with undesired couplings between the controller 40, including the speed controller 402, and the tower 102.

In examples in which the nacelle or tower top velocity in the fore-aft direction is used by the FATD controller 404, the velocity signal may be obtained in any suitable manner. The velocity may for instance be a centre-of-mass velocity of the nacelle 103, the velocity of an appropriate sensor, or the velocity of other fixed points deemed to represent the movement of the nacelle 103 or top of the tower 102 in the fore-aft direction. Indeed, the velocity may, like the position, be determined based on a measured acceleration signal indicative of the nacelle or tower top movement, the acceleration being integrated to obtain the velocity. In a specific example, the tower top velocity used by the FATD controller 404 (i.e. the input signal 405) is the estimated tower top velocity signal 225, obtained as described above.

Now referring back to the gain scheduling controller 409, as described above it is desired to have relatively aggressive intervention from the FATD controller 404—by means of relatively high gains applied to the collective pitch offset signal 406—during transient events, such as extreme load cases, e.g. wind gusts. This means that the gain scheduling controller 409 needs to be able to detect and react quickly to the onset of transient events.

Indeed, a transient event—where the tower 102 may end up in an extreme deflected position (with associated high loading)—can typically be detected earlier than the extreme deflection actually occurs. Hence, determining the gain 410 based on the detection of transient events such as extreme load cases may result in at least partially preventing extreme deflection of the tower 102.

A rapidly increasing wind speed, e.g. during a wind gust, will cause an increase in rotor thrust. A high rotor thrust is associated with a high force at the top of the tower 102. In the described example, the gain scheduling controller 209 therefore determines the gain 410 based on estimated rotor thrust, i.e. the estimated thrust force experienced by the rotor 104. The input signal 411 to the gain scheduling controller 209 therefore comprises an estimated rotor thrust signal. Advantageously, scheduling the gain 410 based on estimated rotor thrust allows for the controller 40 to react quickly to transient events to dampen fore-aft tower oscillations by ramping up the gain 410 applied to the collective pitch offset signal 406.

An increase in rotor thrust when the wind speed has increased rapidly may then be followed by an increase in the velocity of the top of the tower 102 or the nacelle 103 in the fore-aft direction. A high tower top (forward or backward) velocity is associated with high tower deflection and high loads. In the described example, the gain scheduling controller 409 therefore determines the gain 410 additionally based on tower top velocity or nacelle velocity in the fore-aft direction, i.e. the input signal 411 comprises a tower top velocity signal. In particular, in the described example the tower top velocity signal 411 is the estimated tower top velocity signal 225 obtained from the observer model 211, as described above. A gain scheduling scheme—which may also be regarded as a trigger/activation scheme of the FATD controller 404—is implemented such that gains applied to the collective pitch offset signal 406 are increased as necessary. By scheduling the gain 410 based on tower top velocity as well as rotor thrust, the number of activations of the FATD controller 404 is beneficially reduced—thereby reducing pitch fatigue—compared to if the gain 410 is scheduled based on rotor thrust only.

A relatively high tower top velocity is associated with an expectation that a relatively high tower top deflection will follow later in an oscillation cycle. As such, determination of tower top velocity can be used to identify potential high loading scenarios before they occur, meaning that early or preventative action may be taken.

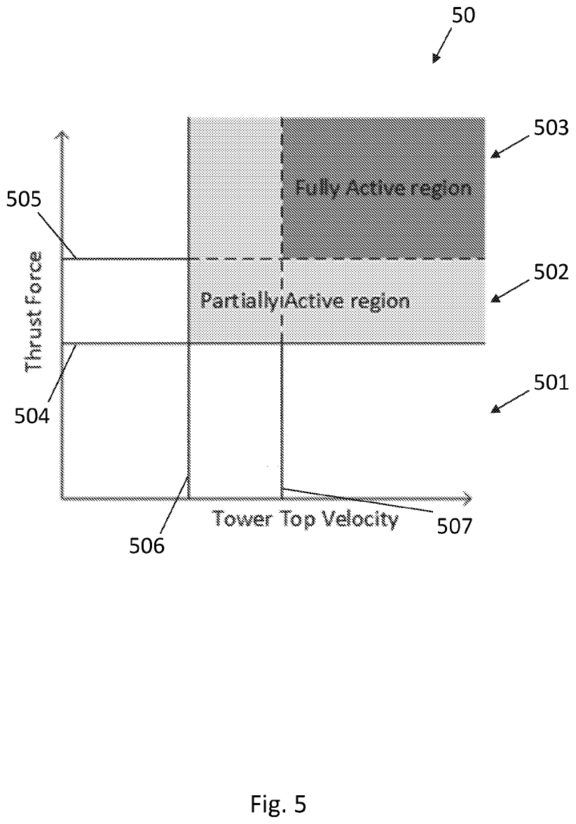

FIG. 5 schematically shows an activation scheme 50 for the FATD controller 404 according to the described example. In particular, FIG. 5 indicates how the gain 410 is determined by the gain scheduling controller 409 based on rotor thrust force and tower top velocity. Specifically, FIG. 5 indicates three activation regions 501, 502, 503: a minimally active (or, optionally, deactivated) region 501, a partially active region 502, and a fully active region 503.

The different activation regions 501, 502, 503 are delineated or separate with reference to respective threshold values related to the rotor thrust force and tower top velocity. Each of the threshold values may be predefined. As indicated in FIG. 5, in the described example each of the rotor thrust force and tower top velocity has two threshold values associated therewith. The thrust force thresholds may be referred to as a first or lower thrust threshold value 504 and a second or upper thrust threshold value 505, the upper threshold value 505 being greater than the lower threshold value 504. In a corresponding manner, the tower top velocity thresholds may be referred to as a first or lower velocity threshold value 506 and a second or upper velocity threshold value 507, the upper threshold value 507 being greater than the lower threshold value 506.

As is apparent from FIG. 5, in the described example if the rotor thrust is less than the lower thrust threshold 504, or the tower top velocity is less than the lower velocity threshold 506, then the activation scheme is in the minimally active region 501. If the rotor thrust is greater than the lower thrust threshold 504, and the tower top velocity is greater than the lower velocity threshold 506, but the rotor thrust is less than the upper thrust threshold 505, or the tower top velocity is less than the upper velocity threshold 507, then the activation scheme is in the partially active region 502. If the rotor thrust is greater than or equal to the upper thrust threshold 505, and the tower top velocity is greater than or equal to the upper velocity threshold 507, then the activation scheme is in the full active region 503.

The gain scheduling controller 409 therefore determines the gain 410 based on which region of the activation scheme 50 operation of the wind turbine 10 is in. For instance, in the minimally active region 501 the gain may be determined to be a minimum gain value. In some examples, this minimum value may be one. This would be regarded as continuing with normal or default operation of the FATD controller 404 as the collective pitch offset signal 206 obtained from the FATD controller 404 would in this case be multiplied by the gain 410 equal to one.

In the fully active region 503 the gain may be determined to be a maximum gain value in order to effect maximum intervention of the FATD controller 404 in such operating conditions. This maximum value may be greater than one, to allow the FATD controller 404 to ramp up its intervention, relative to a normal or default level (which may correspond to a gain value equal to one), during transient events. For instance, the maximum gain value may be two or any other suitable value.

In the partially active region 502, the gain 410 may be determined based on the specific values of thrust force and tower top velocity (obtained from the input signals 411). In the described example, the gain 410 in the partially active region 502 may increase linearly from the minimum gain value when the thrust force equals the lower thrust threshold 504 and/or when the tower top velocity equals the lower velocity threshold 506 to the maximum gain value when the thrust force is greater than or equal to the upper thrust threshold 505 and the tower top velocity is greater than or equal to the upper velocity threshold 506.

In practice, this may be implemented in series, with respective gains being determined for thrust force and tower top velocity, before combining, e.g. multiplying, these together to obtain the (overall) gain 410 to be applied to the collective pitch offset signal 406. That is, a first (thrust) gain may be determined based on the thrust force signal 411, and a second gain (velocity) may be determined based on the tower top velocity signal 411 (where the first and second gains may be determined in either order), with the first and second gains being multiplied together to obtain the overall gain 410. For instance, the first gain may increase linearly from the minimum gain value at the lower thrust threshold 504 to a maximum gain value at the upper thrust threshold 505, and the second gain may increase linearly from the minimum gain value at the lower velocity threshold 506 to a maximum gain value at the upper velocity threshold 507. The determination of gain may be implemented as a look up table of gain values. In other words, a respective gain may vary linearly in each axis direction, with these being combined to determine the overall gain. It will be understood that in different examples, variation other than linear variation may be utilised.

When the FATD controller 404 has reduced the rotor thrust and tower top velocity back to lower levels then the gain may be reverted/decreased back to a normal/default value. However, in order to ensure that the FATD control feature is (sufficiently) active throughout the duration of a transient event, a hold function may be applied to hold the determined gain value at a higher level for at least a defined duration of time. Hence, even if the FATD control feature reduces rotor thrust and tower top velocity to lower levels while a transient event is ongoing, then the gain is held at a higher level for the duration of the event. The defined duration may for instance be of the order of one to two tower fore-aft motion cycles. For instance, if the gain is determined to be the maximum gain value as the wind turbine 10 is operating in the fully active region 503, then if one of the rotor thrust and tower top velocity is reduced to below the respective upper threshold value 505, 507 such that operation is now in the partially active region 502, then the gain may still be held at the maximum gain value for a defined time period. A similar approach may be taken if wind turbine operation is reduced from the partially active region 502 to the minimally active region 301.

In some examples, the FATD controller 404 determines the collective pitch offset signal based on both the fore-aft position and the fore-aft velocity of the tower top or nacelle 103. This may be implemented as determining a first signal based on the obtained tower top position, determining a second signal based on the obtained tower top velocity, and then combining the first and second signals to obtain the collective pitch offset signal. The first and/or second signal may be subject to an applied gain prior to being combined with the other of the first and second signal. In such examples, the gain determined as described above may be applied to only one of the first and second signals, or may be applied to the (overall) collective pitch offset signal.

The described controller(s) may be in the form of any suitable computing device, for instance one or more functional units or modules implemented on one or more computer processors. Such functional units may be provided by suitable software running on any suitable computing substrate using conventional or custom processors and memory. The one or more functional units may use a common computing substrate (for example, they may run on the same server) or separate substrates, or one or both may themselves be distributed between multiple computing devices. A computer memory may store instructions for performing the methods performed by the controller, and the processor(s) may execute the stored instructions to perform the method.

Many modifications may be made to the described examples without departing from the scope of the appended claims.

In the described example, the estimated rotor thrust for input into the observer model is based on a combination of a quasi-static thrust force—obtained, for instance using a blade element model or a thrust coefficient equation—and on a thrust force obtained based on measured blade flap loads. It will be understood that in different examples, the estimated rotor thrust for input into the observer model may be based only on the thrust force obtained based on measured blade flap loads. Such an approach still benefits from being able to quickly react to changes in loading experienced by the wind turbine (i.e. by monitoring blade loading).

1. A method of estimating a velocity of a top of a tower of a wind turbine, the wind turbine comprising a rotor and a plurality of rotor blades, the method comprising:
obtaining a measured acceleration signal indicative of measured acceleration of the top of the tower in the fore-aft direction of the wind turbine;
obtaining an estimated thrust force signal indicative of estimated thrust force experienced by the rotor, and providing the estimated thrust force signal as input to a defined observer model describing motion of the top of the tower;
determining an error signal based on a difference between the measured acceleration signal and an estimated acceleration signal obtained using the defined observer model, and providing the error signal as input to the observer model as part of a feedback loop; and,
determining, using the defined observer model, a velocity signal indicative of estimated velocity of the top of the tower in the fore-aft direction of the wind turbine,
wherein the estimated thrust force signal is obtained based on an obtained blade flap load signal indicative of measured flap loading on the rotor blades.

2. A method according to claim 1, the method comprising:
for each of the plurality of rotor blades, receiving a sensor signal, from a blade load sensor of the respective rotor blade, indicative of measured flap loading on the respective rotor blade; and,
adding the received sensor signals to obtain the blade flap load signal.

3. A method according to claim 1, wherein the estimated thrust force signal is obtained based on a determined quasi-static thrust force signal indicative of quasi-static thrust force experienced by the rotor.

4. A method according to claim 3, wherein the quasi-static thrust force signal is determined using a defined blade element model.

5. A method according to claim 3, the method comprising:
applying a high-pass filter to the obtained blade flap load signal; and,
adding the high-pass filtered blade flap load signal to the quasi-static thrust force signal to obtain the estimated thrust force signal; optionally, wherein a low-pass filter is applied to the quasi-static thrust force signal prior to the addition.

6. A method according to claim 1, the method comprising:
obtaining a collective pitch signal as output from a fore-aft tower damping control routine of the wind turbine, the collective pitch signal being for reducing oscillation amplitude of the top of the tower in the fore-aft direction of the wind turbine;
determining a gain based on the determined velocity signal, and applying the gain to the collective pitch signal to obtain a gain-adjusted collective pitch signal; and,
controlling the rotor blades in accordance with the gain-adjusted collective pitch signal.

7. A method according to claim 6, wherein if the determined velocity signal indicates that the estimated velocity is less than a lower velocity threshold then the gain is determined to be a minimum gain value, or if the determined velocity indicates that the estimated velocity is greater than or equal to an upper velocity threshold then the gain is determined to be a maximum gain value.

8. A method according to claim 7, wherein the gain is determined to increase from the lower velocity threshold to the upper velocity threshold; optionally, wherein the increase is a linear increase.

9. A method according to claim 6, wherein the gain is determined based on the estimated thrust force signal.

10. A method according to claim 9, wherein if the estimated thrust force indicated by the estimated thrust force signal is less than a lower thrust threshold or the estimated velocity indicated by the determined velocity signal is less than a lower velocity threshold, then the gain is determined to be a minimum gain value.

11. A method according to claim 10, wherein the gain is determined to be a maximum gain value only if the estimated thrust force is greater than or equal to an upper thrust threshold, greater than the lower thrust threshold, and the estimated velocity is greater than or equal an upper velocity threshold, greater than the lower velocity threshold.

12. A method according to claim 6, wherein the collective pitch signal is determined based on the determined velocity signal.

13. A method according to claim 6, the method comprising determining, using the defined observer model, a position signal indicative of estimated position of the top of the tower in the fore-aft direction of the wind turbine, wherein the collective pitch signal is determined based on the determined position signal.

14. A controller for estimating a velocity of a top of a tower of a wind turbine, the wind turbine comprising a rotor and a plurality of rotor blades, the controller being configured to:
obtain a measured acceleration signal indicative of measured acceleration of the top of the tower in the fore-aft direction of the wind turbine;
obtain an estimated thrust force signal indicative of estimated thrust force experienced by the rotor, and provide the estimated thrust force signal as input to a defined observer model describing motion of the top of the tower;
determine an error signal based on a difference between the measured acceleration signal and an estimated acceleration signal obtained using the defined observer model, and provide the error signal as input to the observer model as part of a feedback loop; and,
determine, using the defined observer model, a velocity signal indicative of estimated velocity of the top of the tower in the fore-aft direction of the wind turbine,
wherein the estimated thrust force signal is obtained based on an obtained blade flap load signal indicative of measured flap loading on the rotor blades.

15. (canceled)

16. A wind turbine, comprising:
a tower;
a nacelle disposed on the tower;
a rotor extending from the nacelle;
a plurality of rotor blades coupled to the rotor; and
a controller, configured to perform an operation:
obtain a measured acceleration signal indicative of measured acceleration of the top of the tower in the fore-aft direction of the wind turbine;
obtain an estimated thrust force signal indicative of estimated thrust force experienced by the rotor, and provide the estimated thrust force signal as input to a defined observer model describing motion of the top of the tower;
determine an error signal based on a difference between the measured acceleration signal and an estimated acceleration signal obtained using the defined observer model, and provide the error signal as input to the observer model as part of a feedback loop; and
determine, using the defined observer model, a velocity signal indicative of estimated velocity of the top of the tower in the fore-aft direction of the wind turbine,
wherein the estimated thrust force signal is obtained based on an obtained blade flap load signal indicative of measured flap loading on the rotor blades.
